(19) United States
(12) Patent Application Publication
(10) Pub. No.: US 2018/0199382 A1
(43) Pub. Date: Jul. 12, 2018

(54) Client and Access Point Communication Devices and Methods for Random Access Communication

(71) Applicant: Huawei Technologies Co., Ltd., Shenzhen (CN)

(72) Inventors: Genadiy Tsodik, Munich (DE); Shimon Shilo, Munich (DE); Doron Ezri, Munich (DE); Oded Redlich, Munich (DE); Xiao Han, Shenzhen (CN)

(21) Appl. No.: 15/916,837

(22) Filed: Mar. 9, 2018

Related U.S. Application Data
(63) Continuation of application No. PCT/EP2015/070756, filed on Sep. 10, 2015.

(51) Int. Cl. H04W 74/08; H04B 7/26; H04W 8/26

(52) U.S. Cl. CPC H04W 74/0858; H04W 88/08; H04W 8/26; H04B 7/2612

(57) ABSTRACT

A client type communication device for communicating with an access point type communication device is provided. The client type communication device comprises a communication unit adapted to use at least one of first communication resources for performing a random access communication if the client type communication device is in an associated mode regarding the access point type communication device, and to use at least one of second communication resources different from the first communication resources for performing a random access communication to the access point type communication device if the client type communication device is in a non-associated mode regarding the access point type communication device.

### CROSS-REFERENCE TO RELATED APPLICATIONS

This application is a continuation of International Application No. PCT/EP2015/070756, filed on Sep. 10, 2015, the disclosure of which is hereby incorporated by reference in its entirety.

### TECHNICAL FIELD

Embodiments of the invention relate to a client type communication device, an access point type communication device and according communication methods. Especially, it relates to random access communication.

### BACKGROUND

Random access (RA) is a procedure that allows client type communication devices to request from an access point (AP) type communication device resources for transmission by use of a resource request, as well as to initiate an association procedure with the AP. In other words, this mechanism is usually applied by the associated client type communication devices that need to request the resources and also by the new non-associated client type communication devices for the first time to achieve an association with a specific AP.

The number of client type communication devices, which include more and more special devices, like Internet of Things (IoT) clients, grows and is expected to reach very high numbers. Thus, an effective RA mechanism which can manage a large number of clients within a very short time, hence effectively without large overhead, is crucial for future generations of communication systems, especially for future generations of the 802.11 protocol.

Currently, in the 8002.11ax standard, RA is applied immediately after a trigger frame (TF-R), which is transmitted by the AP. Thus the client type communication devices wait for AP to trigger them (indicating the existence of a random access opportunity). A TF-R frame may be followed by several RA opportunities. Within each opportunity, clients can try to access the channel, thereby contending with each other. Two main trends are mentioned here, as examples.

One example is a medium access control (MAC) layer based RA opportunity.

In this technique, the RA is transmitted as regular data, including payload, where each client allocates its transmission within a single resource unit (RU) as defined in 802.11ax. A RU is defined as a set of continuous subcarriers, e.g. 26, over some period of time. The AP can decide to provide more than one RA frame triggered by a single TF-R. The specific frame and the RU within the frame can be chosen in a random way by each client type communication device. No distinguishing between the non-associated client type communication devices and associated client type communication devices is introduced and all the client type communication devices that try to transmit an RA, are allowed to choose any time/frequency resources allocated for the current RA opportunity.

The main disadvantage of the MAC based RA is a very low number of RA resources available within a single frame. For example, in a 20 MHz bandwidth, there are 9 RUs available. When the number of client type communication devices is high, the probability of two or more clients choosing the same time and frequency resources to transmit their RA data is very high. This leads to a large number of collisions which requires RA retransmissions. As a result, the total time required to complete the RA procedure for all the client type communication devices, which try to transmit, can be extremely long. Moreover, the new, not yet associated client type communication devices, which are trying to access the network, interfere with the already associated client type communication devices. This leads to a further reduction in system efficiency. It is important to note that the AP has no idea how many non-associated client type communication devices there are and which of these will try to associate with it. Since these numbers may be large they may significantly increase the collision probability.

Another example is a physical layer (PHY) based RA opportunity.

PHY based RA is transmitted as PHY signaling and does not include any higher layer (MAC or above) payload. Several possibilities regarding PHY based RA, where the RA data is a simple PHY signaling that informs the AP that a specific client type communication device wants resources, are imaginable. The RA data is thus very short and allows a higher number of client type communication devices to be allocated within a single RA frame. However, additional management transmissions are required in this approach to complete the resource request (or association) procedure, since the AP does not necessarily know how many resources the client type communication device requires, etc.

PHY based RA tries to solve the main problem of the MAC based mechanism and enlarge the number of the client type communication devices that can transmit simultaneously and reduce the number of collisions. However, exemplary suggestions are limited in terms of number of client type communication devices they support. This number is not sufficient for the expected huge amount of client type communication devices in future networks.

### SUMMARY

Accordingly, an object of embodiments of the present invention is to provide a client type communication device, an access point type communication device, and according methods, which allow for a great number of client type communication devices in the communication system and at the same time guarantee a high communication efficiency.

The object is solved by the features of the claims for the client type communication device, by the features of the claims for the access point type communication device, by the features of the claims for the according methods and by the features of the claims for the associated computer program. The dependent claims contain further developments.

The scheme presented here introduces a RA mechanism which allows both associated and non-associated client type communication devices to transmit a random access communication within the same frame with zero collisions between associated and non-associated client type communication devices. The special design of RA parameters provides a very efficient transmission scheme for a very large number of client type communication devices, which can be successfully detected by an access point communication device within a very short time period.

Embodiments of the present invention separate random access communication of client type communication devices which have already formed an association with an access point type communication device and are therefore in an associated mode with regard to the access point type communication device from client type communication devices which have not yet formed an association with the access point type communication device and are therefore in a non-associated mode with regard to the access point type communication device.

This differentiation is done by defining different communication resources for the two types of random access communications. First communication resources are used for random access communication by already associated client type communication devices and second communication resources are used for random access communications by client type communication devices which are not yet associated.

Collisions between random access communications of these two different types of client type communication device are therefore completely prevented.

In order to most efficiently assign the communication resources, especially in order to most efficiently divide available communication resources between the first communication resources and the seconds communication resources, the access point type communication device can decide this allocation and broadcast it to the respective client type communication devices as a communication resources setting message.

The communication resources setting message advantageously is a broadcast message sent on specific communication resource(s) known to the client type communication devices. The client type communication devices are then configured to read this/these communication resource(s), to receive the communication resources setting message, and to learn its content. This is done before the client type communication device initiates random access communication or in regular intervals (e.g., within a TF-R message).

Moreover, in order to keep the individual random access communication as short as possible, the random access message sent by the client type communication device advantageously only comprises information regarding the identity of the respective originating client type communication device. A part of the identity can also be coded into the specific communication resource(s) used for transmitting the random access communication.

Rules for determining how the client type communication devices are to construct the random access communications and on which communication resource(s) they should be transmitted on, can also be provided by the access point type communication device. This leads to a high flexibility of the communications.

When receiving a random access communication, the access point communication device is than able to just from the information within the random access communication, especially from the communication resource(s) used, determine if the originating client type communication device is already associated or if it is non-associated, and advantageously also determine the identity of the client type communication device, if it is already associated.

Generally, it has to be noted that all arrangements, devices, elements, units and means and so forth described in the present application could be implemented by software or hardware elements or any kind of combination thereof. Furthermore, the devices may be processors or may comprise processors, wherein the functions of the elements, units and means described in the present applications may be implemented in one or more processors. All steps which are performed by the various entities described in the present application as well as the functionality described to be performed by the various entities are intended to mean that the respective entity is adapted to or configured to perform the respective steps and functionalities. Even if in the following description or specific embodiments, a specific functionality or step to be performed by a general entity is not reflected in the description of a specific detailed element of that entity which performs that specific step or functionality, it should be clear for a skilled person that these methods and functionalities can be implemented in respect of software or hardware elements, or any kind of combination thereof.

### BRIEF DESCRIPTION OF THE DRAWINGS

The present disclosure is in the following explained in detail in relation to embodiments of the invention in reference to the enclosed drawings.

FIG. 1 shows an embodiment of the communication system including an embodiment of the client type communication device and an embodiment of the access point type communication device.

FIG. 2 shows an exemplary set of communication resources.

FIG. 3 shows an exemplary random access block.

FIG. 4 shows an exemplary division of an identification number.

FIG. 5 shows an exemplary set of communication resources when using frequency diversity.

FIG. 6 shows an exemplary set of communication resources when using mapping randomization.

FIG. 7 shows a first embodiment of the method for performing random access.

FIG. 8 shows a second embodiment of the method for performing random access.

FIG. 9 shows an exemplary diagram of timing result gains by use of the embodiments of the invention.

### DETAILED DESCRIPTION OF ILLUSTRATIVE EMBODIMENTS

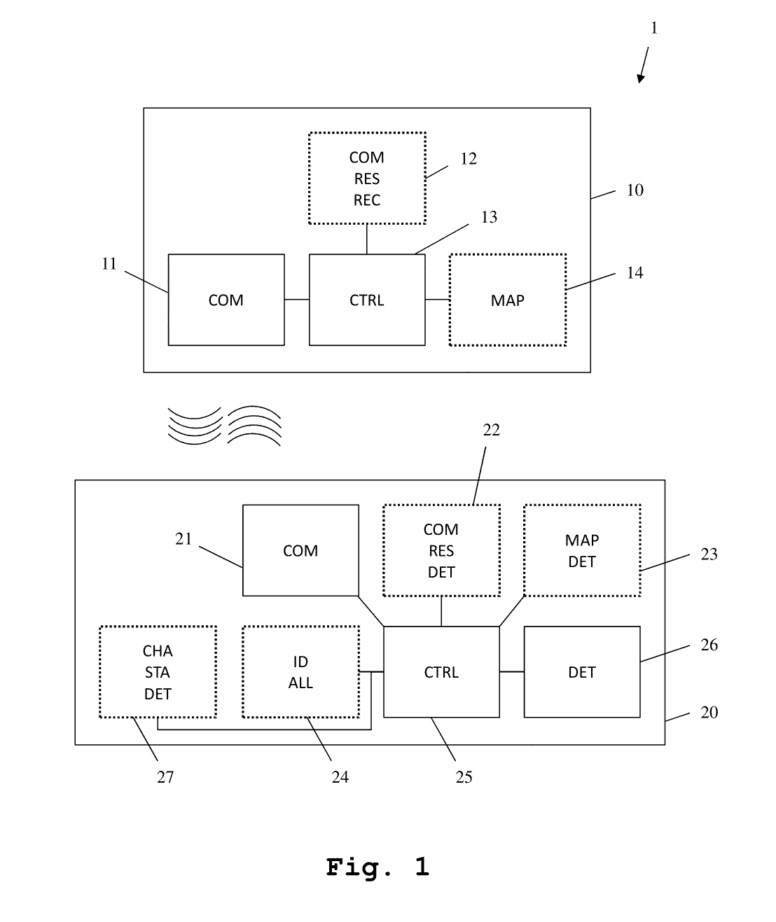

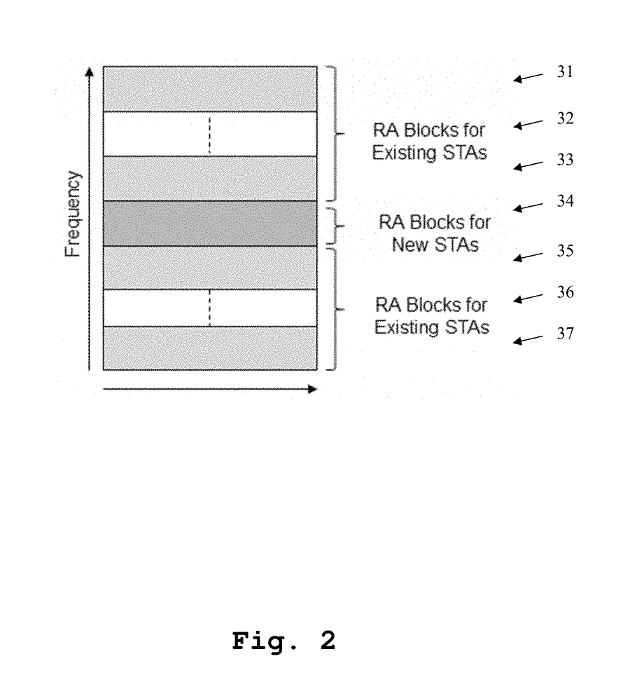

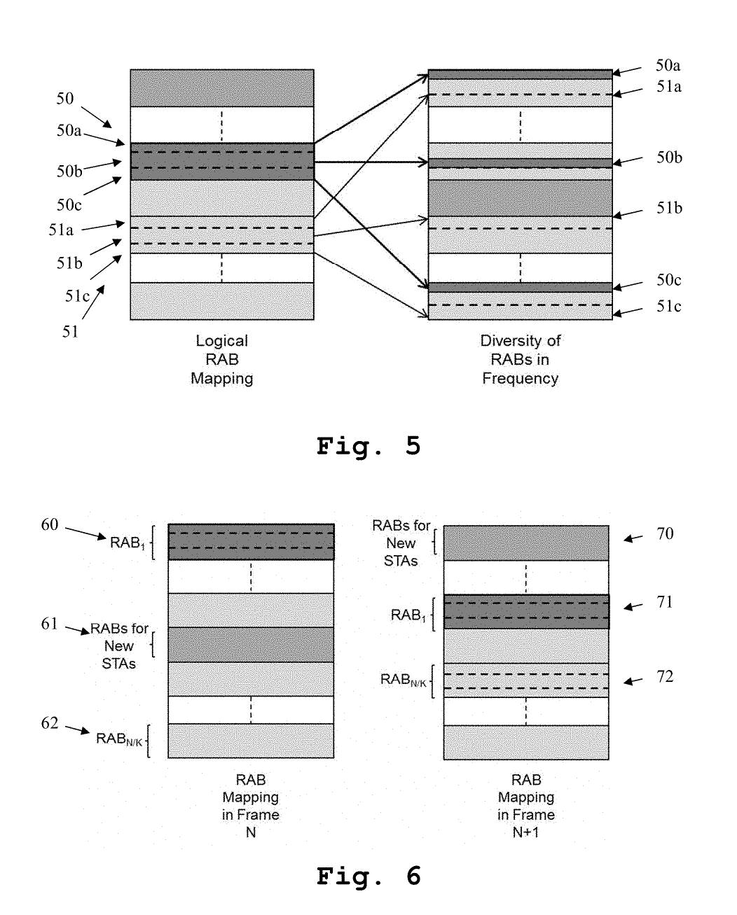

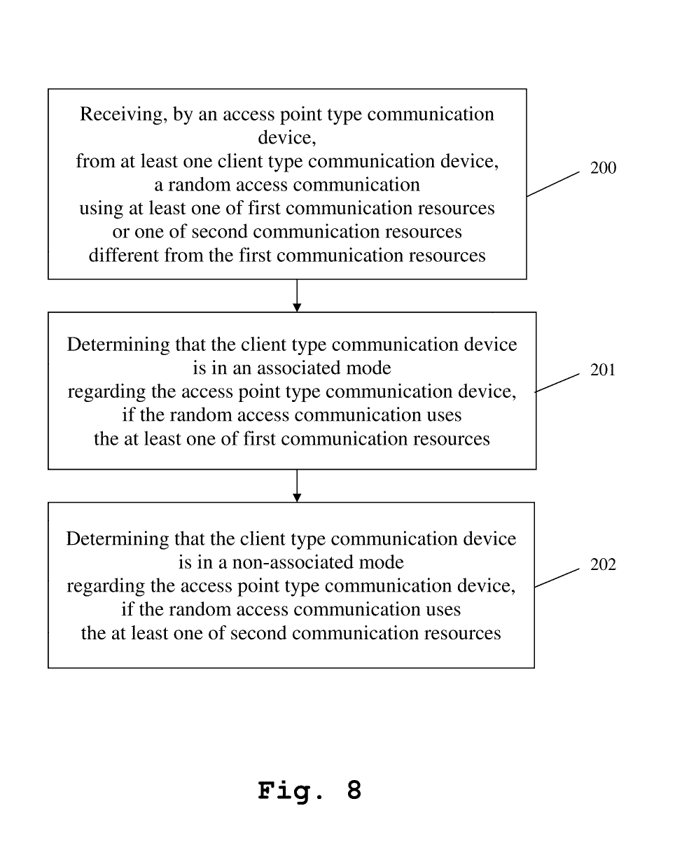

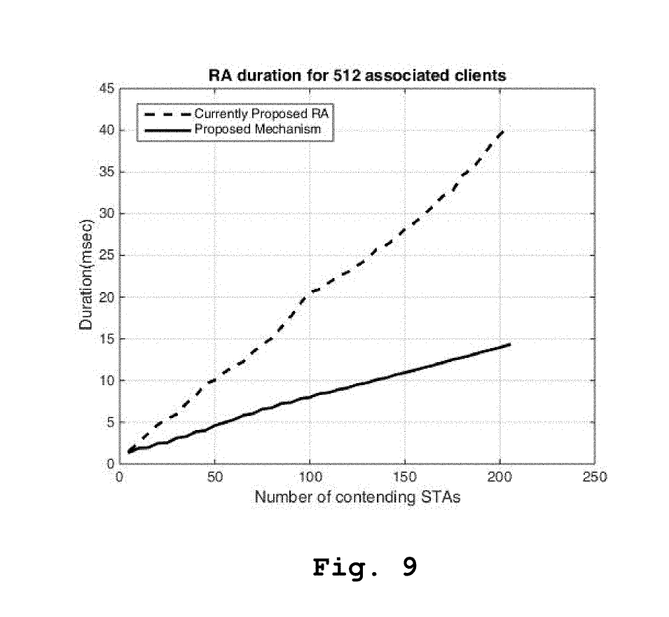

First, the construction and function of an embodiment of a communication system is demonstrated. Especially, the construction and function of embodiments of a client type communication device and access point type communication device are shown in FIG. 1. Second, with reference to FIGS. 2-4, further details of the implementation are described. With reference to FIG. 5 and FIG. 8, the function of embodiments of the communication methods are shown. Finally, with reference to FIG. 9, benefits of the embodiments of the invention are described. Similar entities and reference numbers and different figures have been partially omitted.

In FIG. 1, an embodiment of the communication system 1 (e.g., for a wireless local area network) is shown. The communication system 1 comprises at least one client type communication device to (e.g., for a wireless local area network) and one access point type communication device 20 (e.g., for a wireless local area network).

The client type communication device to comprises a communication unit 11 and a control unit 13. Moreover optionally, it additionally comprises a communication resources receiving unit 12 and a mapping unit 14. The communication unit 11, the communication resources receiving unit 12, and the mapping unit 14 are each connected to the control unit 13. The control unit 13 is adapted to control all other units 11, 12 and 14.

When performing a random access communication to the access point type communication device 20, the communication unit 11 uses one of first communication resources if the client type communication device to is in an associated mode regarding the access point type communication device 20, and uses one of second communication resources if the client type communication device to is in a non-associated mode regarding the access point type communication device 20. The first communication resources and the second communication resources are non-identical. It is thereby assured that no collisions can occur between messages of client type communication devices to which are in an associated mode and client type communication devices to which are in a non-associated mode.

The first and second communication resources each are random access blocks. These random access blocks can comprise contiguous or non-contiguous frequency sections. The use of non-contiguous frequency sections allows for frequency diversity and alleviates drawbacks from suboptimal transmission conditions on a part of the available spectrum.

A random access block typically comprises a plurality of frequency subcarriers and a plurality of time slots. A frequency section comprises at least one such frequency subcarrier but typically a plurality of neighboring (the spacing between two neighboring frequency subcarriers depends on what is defined by the underlying communication system) frequency subcarriers.

A random access block comprising contiguous frequency sections therefore comprises a plurality of neighboring frequency subcarriers, with no frequency subcarriers in-between not belonging to the random access block.

A random access block comprising non-contiguous frequency sections therefore comprises a plurality of frequency subcarriers wherein between at least some of them further frequency subcarriers are existent which do not belong to this random access block. Hence, such random access block can be understood to be spread over frequency.

Moreover, if the random access communication is indeed spread over a number of frequencies, channel properties can be used for determining a transmission channel state of the communication channel between the client type communication device and the access point type communication device. This information later on can be used for link adaptation. Especially, it can be used for deciding which frequencies (or frequency subcarriers) are most suitable for achieving a high throughput.

Also, time diversity might be applied to deal with burst errors due to occasional noise on the transmission channel. In this case, the random access blocks of the first and second communication resources comprise non-contiguous time sections.

The communication resources receiving unit 12 is adapted to receive, from the access point type communication device 20, a communication resources setting message which defines the first and second communication resources. The first and second communication resources defined by this message are then used by the communication unit 11.

If the client type communication device to is in the associated mode with regard to the access point type communication device 20, the mapping unit 14 advantageously determines at least a part of the random access communication (such as a random access sequence to be used) and the first communication resources used for performing the random access communication based on an identification number of the client type communication device to according to a mapping rule.

As an example, the mapping unit 14 can be configured to determine the random access sequence based on a first part of an identification number of the client type communication device to according to the mapping rule. Moreover, it can be configured to select the at least one of the first communication resources used for performing the random access communication, based on a second part of the identification number, according to the mapping rule. In another example, the second part of the identification can be used to determine the random access sequence and the first part is used to determine the at least one of the first communication resources.

The mapping rule as well as the identification number can advantageously be received from the access point type communication device 20. The identification number is in this case received in an identification number allocation message. The mapping rule is in this case received in a mapping rule allocation message.

In order to keep the random access communication short, the random access communication message from the client type communication device to the access point type communication type advantageously only comprises the information necessary for uniquely identifying the client type communication device or for announcing a resource request of the client type communication device 10. Additional information is provided from the client type communication device to only after the access point type communication device 20 has requested it.

The access point type communication device 20 comprises a communication unit 21, a control unit 25, and a determining unit 26. Optionally, it additionally comprises an identification number allocation unit 24, a communication resources determining unit 22, a mapping determining unit 23, and a channel state determining unit 27. The control unit 25 is connected to all the remaining units 21, 22, 23, 24, 26 and 27, and adapted to control them.

The communication unit 21 receives from the at least one client type communication device to a random access communication using at least one of first communication resources or one of second resources different from the first communication resources. The determining unit 26 determines from the use of the first or second communication resources, if the client type communication device to is in an associated mode regarding the access point type communication device 20 or in a non-associated mode regarding the access point type communication device 20. Advantageously, it can additionally determine therefrom, the identity of the client type communication device to, if it is in the associated mode.

If the client type communication device to is in non-associated mode the client type communication device to is configured to randomly choose the random access sequence and the at least one of the second communication resources (i.e., a Random access block for the non-associated state). The access point type communication device 20 is configured to initiate the association procedure with this specific non-associated client type communication device to based on the chosen sequence and resource(s) used for the random access communication.

The communication resources determining unit 12 determines the first and second communication resources. Especially, it does this based upon a number of client type communication devices associated to the access point type communication device 20 and/or a frequency of receiving random access communications from client type communication devices not associated to the access point communication device 20 and/or a number of detected random access communication collisions. The communication unit 21 transmits (e.g. broadcasts) the communication resources setting message, which defines the first and second communication resources to the client type communication devices to.

The number of resources and the size of resources allocated to already associated devices and not yet associated devices can be based upon the number of available resources and/or the number of already associated devices. In case of a low number of associated devices, a large portion of the available resources (e.g., random access blocks, each comprising a certain number time slots and frequency subcarriers) can be allocated to non-associated devices, while when the number of associated devices is high, a higher portion of the available resources should be allocated to the already associated devices.

The identification number allocation unit 24 allocates an identification number to each client type communication device to, which establishes an association with the access point type communication device 20. This identification number is then transmitted to the client type communication device to by use of the communication unit 21 as an identification number allocation message.

The mapping rule determination unit 23 determines a mapping rule, where the mapping rule defines how a client type communication device to associated to the access point type communication device 20 has to determine from (e.g., a first or second part of) the identification number, a part of the random access communication (such as the random access sequence) and from (e.g., from a second or first part of) the identification number, the at least one of first communication resources to be used for performing the random access communication. The mapping rule is transmitted to the client type communication device(s) 10 by the communication unit 21 as a mapping rule allocation message. Also, this mapping rule allocation message can be broadcasted by the access point type communication device 20.

In order to randomize the frequencies allocated to a specific client type communication device to, the mapping rule can be changed at regular or irregular intervals. This is useful for mitigating frequency specific drops in transmission conditions (in other words benefiting from frequency diversity).

The channel state determining unit 27 determines channel properties on at least two specific non-contiguous frequency sections (each comprising at least one frequency subcarrier) from the random access communication received by the communication unit 21. It then determines a transmission channel state from the channel properties on the at least two specific non-contiguous frequency sections. The communication unit 21 allocates resources for an uplink and/or downlink payload data transmission to the client type communication device to, based upon the transmission channel state determined by the channel state determining unit 27. Thereby, the payload transmission can be optimized to channel conditions.

In FIG. 2, a number of communication resources 31-37 are shown. The communication resources 31-37 are time- and frequency-sections of the available spectrum. The communication resources 31, 32, 33, 35, 36 and 37 are dedicated to client type communication devices, which are in an associated mode with regard to the access point type communication device. At the same time communication resource 34 is dedicated to client type communication devices, which are in a non-associated mode with regard to the access point type communication device. A random access block (RAB) is defined as a basic random access communication resource.

In order to allow for a flexibility to adjust the RA frame to a total number of available client type communication devices, the whole bandwidth can be divided into N/K RABs (Random access blocks), where N is a total number of elements, for example (frequency) subcarriers, and K is a size of a single RAB, in units of elements/subcarriers. The exact parameters can be chosen by the access point type communication device according to the requirements of the communication system or network and be transmitted to the informed to the client type communication devices within the TF-R. Especially this information can be generated by the communication resources determining unit 22 of the access point type communication device 20 and can be transmitted in the communication resource allocation message.

In order to support a large number of client type communication devices, a narrow RAB should be chosen. For example, assuming the numerology of the 802.11ax standard, if K=3 the number of RABs is

$$N / K = \frac{234}{3} = 78.$$

The duration in time combined with the structure in frequency defines the maximum number of the client type communication devices, which can be detected with no collision within a single RAB. If a number of OFDM symbols that is allocated for the RA frame is M as shown on FIG. 3, the total number of RA communication resources within a single RAB is MK. This number is a maximum number of RA transmissions that can be detected simultaneously, for example, every client type communication device transmits only on a single RA resource.

The access point type communication device can decide, based on the network conditions which size of RAB is most suitable for current system requirements, how many RABs should be dedicated for the associated clients and what is the required time duration of the RA frame.

Since the transmission conditions on different frequencies greatly vary, it is useful to vary the communication resources allocated to different client type communication devices, and also to vary the communication resources allocated to associated and non-associated client type communication devices.

Also, for mitigating this problem, the communication resources can be chosen in non-contiguous manner. That is, the communication resources can be chosen so that frequency sections are used, which do not lie beside each other in the spectrum. This means that the K RA resources can be spread in frequency and should not be allocated in an adjacent manner. For example, if K=3 the resource elements (e.g., frequency subcarriers) that are marked for the 1st RAB can be defined as 1, 75 and 149; the resource elements that are marked for the 2nd RAB are 2, 76 and 150 and so on.

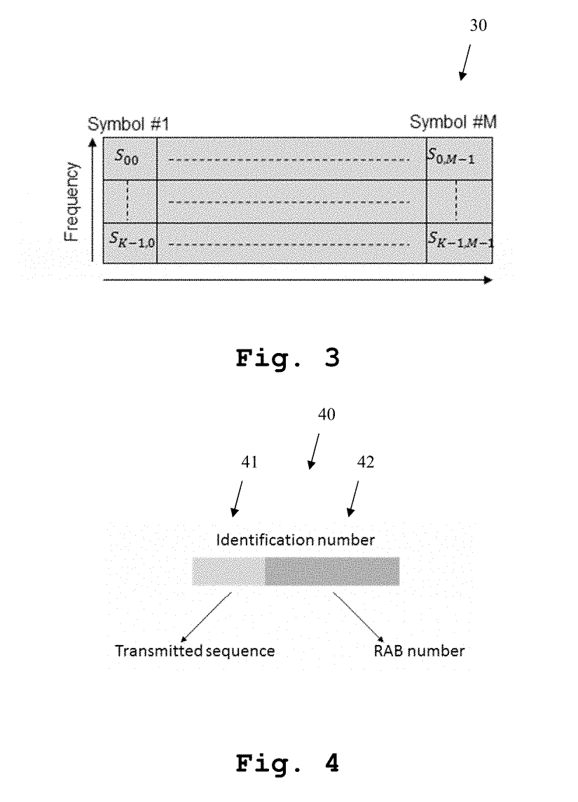

In order to reduce the length of a random access communication of a client type communication device to an access point type communication device to a minimal length, and in order to ensure a collision free transmission for the associated client type communication devices, it is proposed that the allocation of an RAB for the specific client type communication device and the RA communication that should be transmitted within each RAB are to be based on a one-to-one mapping originating in an identification number of the client type communication device. This is shown in FIG. 4. An identification number 40 has a first part 41 and a second part 42. The first part 41 is used for determining the content (e.g., a sequence) of the random access communication. This is done according to a mapping rule which is either preset or provided to the client type communication device to, by the mapping determining unit 23 and the communication unit 21 of the access point type communication device 20.

Especially, each client type communication device transmits a sequence which is defined by the first part 41 of its Identification number 40. All sequences used within any one of the RAB are orthogonal to each other. The sequences though can be reused in different RABs. For example, each client type communication device may transmit a Walsh-Hadamard code as part of the random access communication. Within each RAB, several respective codes can be transmitted, and each client type communication device's code is pre-defined according to its Identification number 40 so both client type communication device and access point type communication device know which code will be chosen.

As already pointed out earlier, the mapping rule determines how the part of the random access communication is determined from the first part 41 of the identification number 40 can be dynamically assigned.

Moreover, information can also be transmitted by the client type communication device to by selecting the specific communication resource used for transmitting the random access communication. The RAB number (which resource out of the first communication resources is to be used for the random access communication) can be determined based upon the second part 42 of the identification number by use of the mapping rule, mentioned earlier.

For example, the RAB number can be calculated from the second part 42 of the Identification number 40 of a client type communication device using a modulo of a number of RABs dedicated for the associated client type communication devices. For example, in case of 74 RABs, client type communication devices with identification numbers 1 and 75 should transmit within the 1st RAB while client type communication devices with identification numbers 3 and 77 should transmit within the 3rd RAB.

Also, the mapping rule defines how this determination of the random access block to be used is performed. Also here, the mapping rule may be pre-specified or dynamically set by the access point type communication device 20, especially by the mapping determining unit 23 and the communication unit 21.

For example, one may define a permanent mapping function which is unique, predefined, and which depends on the parameters mentioned above. When a client type communication device receives the mapping allocation message with the RA parameters mentioned above, it can derive the permanent mapping function from this set of parameters. A second mapping function is a temporary mapping function which can be defined as a change that is to be applied on the permanent function in the current RA frame.

For example, the permanent mapping function can define that the RAB number equals to an identification number of a client modulo a number of RABs. The temporary mapping function can define that all the client type communication devices should add a constant value to their identification number and then apply the permanent mapping function. This can assist with gradually changing the allocated resource per client over time. Denoting this value as p, it can be easily understood that the clients 1 and 75 should transmit within p-th RAB while client 3 and 77 should transmit within p+2-th RAB.

When receiving a random access communication from a client type communication device to, the access point type communication device 20 is then directly able to determine, on the one hand, if the client type communication device to is in an associated mode with regard to the access point type communication device 20 or in a non-associated mode with regard to the access point type communication device 20, and on the other hand, if the client type communication device to is in the associated mode, determine the identity of the client type communication device to.

The total number of the associated client type communication devices that can transmit with no collision within the single RA frame is defined by the number of the orthogonal sequences and the number of RABs dedicated for associated client type communication devices. For example, if 74 out of 78 RABs are dedicated to the associated client type communication devices and the number of the orthogonal sequences within each RAB is 7, the total number of 518 associated clients can successfully be detected with no collision within the single RA frame.

In FIG. 5, an exemplary set of communication resources, when using the above-described frequency diversity, is shown.

On the left side, two random access blocks 50, 51 are shown. The random access block 50 consists of three frequency-contiguous frequency sections 50a, 50b, 50c. The random access block 51 consists of three frequency-contiguous frequency sections 51a, 51b, 51c.

On the right side, that same situation after applying frequency diversity is shown. Now the random access blocks 50, 51 are spread over a large portion of the available spectrum. This solution is beneficial, since frequency dependent noise is divided upon the different random access blocks and not concentrated in a single random access block.

In FIG. 6, an exemplary set of communication resources, when using the above-described mapping randomization, is shown.

On the left side, a mapping of a frame N is shown. Here random access blocks 60 and 62 are used for already allocated client type communication devices and a random access block 61 is used for not yet allocated client type communication devices. Since frequency dependent noise can negatively affect the respective random access blocks 60, 61 and 62, in a further frame N+1, the frequency location of the frames is shifted.

On the right side, a mapping of a frame N+1 is shown. Here it can be clearly seen that now random access blocks 71 and 72 are used for already allocated client type communication devices and random access block 70 is used for not yet allocated client type communication devices. The random access blocks 60, 62 and the random access blocks 71, 72 do not overlap. Also, the random access blocks 61 and 70 do not overlap.

Also, by this measure frequency dependent noise is divided upon the different random access blocks. The impact of such noise on specific client type communication devices is mitigated.

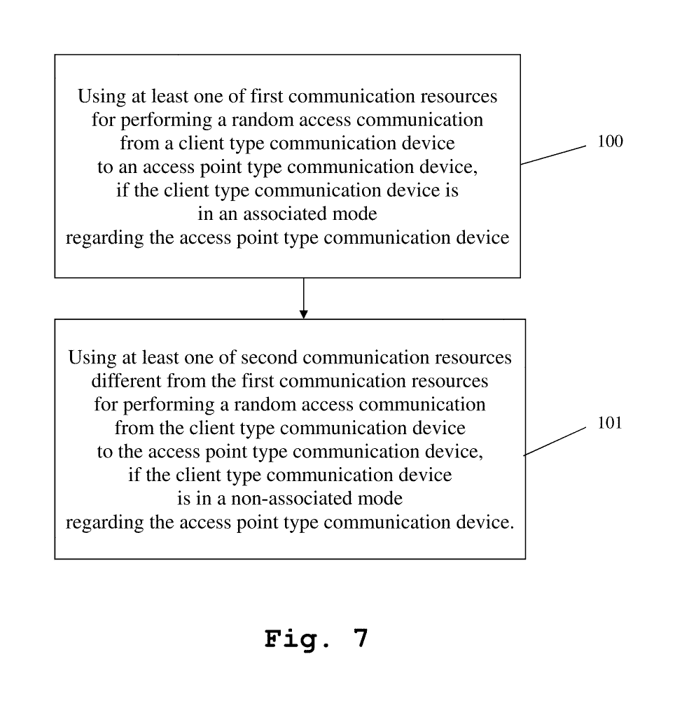

In FIG. 7 an embodiment of a communication method is shown. Here, the transmission side is described. In a first step too, at least one of first communication resources is used for performing a random access communication from a client type communication device to an access point type communication device, if the client type communication device is in an associated mode regarding the access point type communication device. In a second step lot which does not necessarily have to happen after the first step too, at least one of a second communication resources different from the first communication resources is used for performing a random access communication from the client type communication device to the access point type communication device, if the client type communication device is in a non-associated mode regarding the access point type communication device.

In FIG. 8, an embodiment of a further communication method is shown. Here, the receiving side is described. In a first step 200, an access point type communication device receives from at least one client type communication device, a random access communication using at least one of first communication resources or one of second communication resources different from the first communication resources. In a second step 201, it is determined that the client type communication device is in an associated mode regarding the access point type communication device, if the random access communication uses the at least one first communication resources. In a third step 202, which does not necessarily have to occur after the second step 201, it is determined that the client type communication device is in a non-associated mode regarding the access point type communication device, if the random access communication uses at least one of second communication resources.

Finally, in FIG. 9, benefits of embodiments of the present invention are shown. Here, the total time duration for completing the random access mechanism for all contending associated and non-associated client type devices is shown on the y axis, while the number of contending client type communication devices is shown on the x-axis. Especially, in this case, 512 client type communication devices are associated with the AP device. It can clearly be seen, that the proposed mechanism according to embodiments of the present invention, shown by a solid line, has a significantly shorter random access duration for any number of client type communications to be associated, than the previously used random access scheme shown by a dashed line.

By use of embodiments of the invention, it is possible to effectively enlarge and adjust the number of supported client type communication devices to the number of associated client type communication devices. Moreover, it is possible to increase the system efficiency. Especially, by choosing suitable random access parameters, such as given by the mapping rule and/or the communication resource determining message, the efficiency can be significantly improved.

Therefore, an improved random access performance is achieved. This can furthermore be increased by using the above-mentioned described frequency diversity and mapping randomization.

The embodiments of the present invention are not limited to the communication schemes listed above. An application in any random access based communication scheme is possible. The characteristics of the exemplary embodiments can be used in any advantageous combination.

The invention has been described in conjunction with various embodiments herein. However, other variations to the disclosed embodiments can be understood and effected by those skilled in the art in practicing the claimed invention, from a study of the drawings, the disclosure and the appended claims. In the claims, the word “comprising” does not exclude other elements or steps and the indefinite article “a” or “an” does not exclude a plurality. A single processor or other unit may fulfill the functions of several items recited in the claims. The mere fact that certain measures are recited in usually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the internet or other wired or wireless communication systems.

What is claimed is:

1. A client device, comprising:
a processor; and
a computer-readable storage medium storing a program to be executed by the processor, the program including instructions for:
when the client device is associated with an access point, performing a random access communication to the access point using a first communication resource, wherein the client device is associated with the access point when it has previously formed an association with the access point; and
when the client device is not associated with the access point, performing a random access communication to the access point using a second communication resource, the second communication resource being different than the first communication resource, wherein the client device is not associated with the access point when it has not previously formed an association with the access point.

2. The client device of claim 1, wherein the first communication resource and the second communication resource are each random access blocks respectively comprising at least two non-contiguous frequency sections.

3. The client device of claim 1, wherein the program further includes instructions for:
receiving, from the access point, a communication resources setting message, the communication resources setting message defining one or more first communication resources for client devices in an associated mode or defining one or more second communication resources for client devices not in the associated mode, wherein the one or more first communication resources includes the first communication resource, and wherein the one or more second communication resources includes the second communication resource.

4. The client device of claim 1, further comprising an identification number, wherein the program further includes instructions for:
when the client device is associated with the access point, determining, according to a mapping rule, a configuration of the random access communication based on the identification number of the client device; and
selecting, according to the mapping rule, the first communication resource used for performing the random access communication based on the identification number.

5. The client device of claim 4, wherein the program further includes instructions for:
when the client device is associated with the access point, receiving, from the access point, an identification number allocation message, the identification number allocation message allocating the identification number to the client device; or
receiving a mapping rule allocation message, the mapping rule allocation message defining the mapping rule.

6. The client device of claim 1, wherein the program further includes instructions for transmitting the random access communication to the access point, wherein the random access communication comprises only information either identifying the client device or announcing a resource request of the client device.

7. An access point, comprising:
a processor; and
a computer-readable storage medium storing a program to be executed by the processor, the program including instructions for:
receiving, from a client device, a random access communication on one or more first communication resources or on one or more second communication resources, wherein the one or more first communication resources are different from the one or more second communication resources;
determining that the client device is in an associated mode with the access point when the random access communication uses a first communication resource of the one or more first communication resources, wherein the client device is in the associated mode with the access point when it has previously formed an association with the access point; and
determining that the client is in a non-associated mode with the access point, if the random access communication uses a second communication resource of the one or more second communication resources, wherein the client device is not in the associated mode with the access point when it has not previously formed an association with the access point.

8. The access point of claim 7, wherein the one or more first communication resources and the one or more second communication resources are each random access blocks comprising at least two non-contiguous frequency sections.

9. The access point of claim 7, wherein the program further includes instructions for:
determining the one or more first communication resources and the one or more second communication resources, the determining being based on:
a number of client type communication devices associated with the access point,
a frequency of receiving random access communications from client type communication devices not associated to the access point, or
a number of detected random access communication collisions; and
transmitting, to the client device, a communication resources setting message, which defines the one or more first communication resources or the one or more second communication resources.

10. The access point of claim 9, wherein the communication resources setting message is transmitted as a broadcast message.

11. The access point of claim 7, wherein the access point is associated with one or more client type communication devices, the one or more client type communication devices including the client device, and wherein the program further includes instructions for:
allocating an identification number to each client type communication device associated with the access point; and
transmitting an identification number allocation message to each client type communication device associated to the access point, the identification number allocation message providing the client device its identification number.

12. The access point of claim 11, wherein the program further includes instructions for:
determining a mapping rule, wherein the mapping rule defines communication resources based on the identification number, wherein the one or more client type communication devices determine, from a first part of the identification number, a configuration of the random access communication to the access point, wherein the one or more client type communication devices determine from a second part of the identification number the one or more first communication resources for performing random access communication to the access point; and
transmitting a mapping rule allocation message to each of the one or more client type communication device associated with the access point, the mapping rule allocation message providing the mapping rule to each of the one or more client type communication devices.

13. The access point of claim 12, wherein the program further includes instructions for:
altering the mapping rule at intervals; and
transmitting a new mapping rule allocation message to each of the one or more client type communication devices associated with the access point, the new mapping rule allocation message providing each of the one or more client type communication devices with the altered mapping rule.

14. The access point of claim 7, wherein the one or more first communication resources and the one or more second communication resources are each random access blocks comprising at least two specific non-contiguous frequency sections, and wherein the program further includes instructions for:
determining channel properties on the at least two specific non-contiguous frequency sections from a received random access communication;
determining a transmission channel state from the channel properties on the at least two specific non-contiguous frequency sections; and
allocating resources for an upload or download data transmission to the client device, based upon the transmission channel state determined by the channel state determining unit.

15. A method, comprising:
when a client device is in an associated mode with an access point, transmitting, from the client device, a random access communication over a first communication resource to the access point, wherein the client device is in the associated mode with the access point when it has previously formed an association with the access point; and
when the client device is not in the associated mode with an access point, transmitting, from the client device, a random access communication over a second communication resource to the access point, wherein the second communication resource is different than the first communication resource, wherein the client device is not in the associated mode with the access point when it has not previously formed an association with the access point.

16. The method of claim 15, further comprising:
receiving, by the client device, a communication resources setting message from the access point, the communication resources setting message defining one or more first communication resources for client devices in the associated mode or defining one or more second communication resources for client devices not in the associated mode, wherein the one or more first communication resources includes the first communication resource and wherein the one or more second communication resources includes the second communication resource.

17. The method of claim 15, wherein the client device comprises an identification number, the method further comprising:
when the client device is in the associated mode with the access point, determining, according to a mapping rule, a configuration of the random access communication based on the identification number of the client device; and
selecting, according to the mapping rule, the first communication resource used for performing the random access communication based on the identification number.

18. A method, comprising:
receiving, by an access point, a random access communication from a client device over one or more first communication resources or over one or more second communication resources, wherein the one or more second communication resources are different than the one or more first communication resources; and
determining whether the client device is in an associated mode with the access point based on communication resources used by the random access communication, wherein the random access communication received over the one or more first communication resources indicates that the client device is in an associated mode, wherein the random access communication received over the one or more second communication resources indicates that the client device is not in the associated mode, wherein the client device is not in the associated mode with the access point when it has not previously formed an association with the access point.

19. The method of claim 18, further comprising:
determining the one or more first communication resources and the one or more second communication resources, based upon:
a number of client type communication devices associated with the access point, a frequency of receiving random access communications from client type communication devices not associated to the access point, or
a number of detected random access communication collisions; and
transmitting, to the client device, a communication resources setting message, which defines the one or more first communication resources or the one or more second communication resources.

20. The method of claim 18, wherein the access point is associated with one or more client type communication devices, the one or more client type communication devices including the client device, the method further comprising:
allocating an identification number to each client type communication device associated with the access point; and
transmitting an identification number allocation message to each client type communication device associated to the access point, the identification number allocation message providing the client device its identification number.
